(19) United States
(12) Patent Application Publication
(10) Pub. No.: US 2019/0005435 A1
(43) Pub. Date: Jan. 3, 2019

(54) SYSTEM AND METHOD FOR ALLOCATING HUMAN RESOURCES BASED ON BIO INSPIRED MODELS

(71) Applicant: HCL Technologies Limited, Noida (IN)

(72) Inventors: Ashutosh SHUKLA, Noida (IN); Satya Sai Prakash KANAKADANDI, Hyderabad (IN); S U M Prasad DHANYAMRAJU, Hyderabad (IN)

(21) Appl. No.: 16/013,838

(22) Filed: Jun. 20, 2018

(30) Foreign Application Priority Data
Jun. 28, 2017 (IN) 201711022670

(51) Int. Cl. G06Q 10/06; G06Q 10/10; G06N 3/12

(52) U.S. Cl. CPC G06Q 10/063112; G06N 3/126; G06Q 10/103; G06Q 10/06313

(57) ABSTRACT

The present disclosure relates to system(s) and method(s) for allocating human resources based on bio inspired models. The system receives primary data associated with a product under development. The primary data may comprise a set of tasks associated with the product under development. Further, the system identifies a sub-set of human resources, from a set of human resources, maintained at a human resource database, based on a resource identification algorithm. Furthermore, the system extracts secondary human resource data associated with the sub-set of human resources from the human resource database. The system further allocates one or more human resources from the sub-set of human resources to each task from the set of tasks based on a resource allocation algorithm. The resource allocation algorithm is configured to analyse the secondary human resource data and the primary data to allocate the one or more human resources.

### CROSS-REFERENCE TO RELATED APPLICATIONS AND PRIORITY

The present This present application claims benefit from Indian Complete Patent Application No 201711022670 filed on 28 Jun. 2017, the entirety of which is hereby incorporated by reference.

### TECHNICAL FIELD

The present disclosure in general relates to the field of resource allocation. More particularly, the present invention relates to a system and method for allocating human resources in the field of software engineering and development.

### BACKGROUND

In software industry, it is important to launch a software product or service on time and ahead of competitors. Further, delay in the launch of the software product or service may lead to substantial revenue and reputation losses. Generally, the software industry spends lot of time in training human resources to acquire skills that are required to complete development of the software product. The human resources such as developers, testers and system engineers plays an important role in a software development life cycle. The software development life cycle comprises tasks such as development, maintenance, and testing of the software product. In order to launch/release the software product on time, it is necessary to allocate appropriate human resources with requisite skills, experience, ability, domain knowledge and plethora of soft skills, to each task in the software development life cycle.

Further, a project manager spends lot of time to allocate the skilled human resources to the tasks in the software development life cycle. Generally, a project manager allocates the human resources to the tasks based on complexity of the task and experience of the human resources in the organization. However, it may be difficult for the project manager to accurately analyse experience and assess capability of each team member.

### SUMMARY

Before the present systems and methods for allocating human resources based on bio inspired models, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and method for allocating human resources based on bio inspired models. This summary is not intended to identify essential features of the claimed subject matter nor is it intended for use in determining or limiting the scope of the claimed subject matter.

In one implementation, a method for allocating human resources based on bio inspired models is illustrated. The method may comprise receiving primary data associated with a product under development. In one embodiment, the primary data may comprise a set of tasks associated with the product under development. Further, the method may comprise identifying a sub-set of human resources from a set of human resources based on a resource identification algorithm. In one embodiment, the set of human resources may be maintained at a human resource database. Further, the resource identification algorithm may be configured to analyse the set of tasks to identify the sub-set of human resources. The method may further comprise extracting secondary human resource data associated with the sub-set of human resources from the human resource database. Further, the method may comprise allocating one or more human resource from the sub-set of human resources to each task from the set of tasks based on a resource allocation algorithm. In one embodiment, the resource allocation algorithm may be configured to analyse the secondary human resource data and the primary data for allocating the one or more human resources.

In another implementation, a system for allocating human resources based on bio inspired models is illustrated. The system comprises a memory and a processor coupled to the memory, further the processor is configured to execute programmed instructions stored in the memory. In one embodiment, the processor may execute programmed instructions stored in the memory for receiving primary data associated with a product under development. In one embodiment, the primary data may comprise a set of tasks associated with the product under development. The processor may further execute programmed instructions stored in the memory for identifying a sub-set of human resources from a set of human resources based on a resource identification algorithm. In one embodiment, the set of human resources may be maintained at a human resource database. Further, the resource identification algorithm may be configured to identify the sub-set of human resources based on analysis of the set of tasks. Furthermore, the processor may execute the programmed instructions stored in the memory for extracting secondary human resource data associated with the sub-set of human resources from the human resource database. The processor may further execute the programmed instructions stored in the memory for allocating one or more human resource from the sub-set of human resources to each task from the set of tasks based on a resource allocation algorithm. In one embodiment, the resource allocation algorithm may be configured to analyse the secondary human resource data and the primary data to allocate the one or more human resources.

In yet another implementation, a computer program product having embodied computer program for allocating human resources based on bio inspired models is disclosed. The program may comprise a program code for receiving primary data associated with a product under development. In one embodiment, the primary data may comprise a set of tasks associated with the product under development. Further, the program may comprise a program code for identifying a sub-set of human resources from a set of human resources based on a resource identification algorithm. In one embodiment, the set of human resources may be maintained at a human resource database. Further, the resource identification algorithm may be configured to identify the sub-set of human resources based on analysis of the set of tasks. Furthermore, the program may comprise a program code for extracting secondary human resource data associated with the sub-set of human resources from the human resource database. The program may further comprise a program code for allocating one or more human resource from the sub-set of human resources to each task from the set of tasks based on a resource allocation algorithm. In one embodiment, the resource allocation algorithm may be configured to analyse the secondary human resource data and the primary data to allocate the one or more human resources.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for allocating human resources based on bio inspired models, in accordance with an embodiment of the present subject matter.

FIG. 2 illustrates the system for allocating human resources based on bio inspired models, in accordance with an embodiment of the present subject matter.

FIG. 3 illustrates a method for allocating human resources based on bio inspired models, in accordance with an embodiment of the present subject matter.

### DETAILED DESCRIPTION

Some embodiments of the present disclosure, illustrating all its features, will now be discussed in detail. The words “receiving”, “identifying”, “extracting”, “allocating”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. Although any systems and methods similar or equivalent to those described herein can be used in the practice or testing of embodiments of the present disclosure, the exemplary, systems and methods for allocating human resources based on bio inspired models are now described. The disclosed embodiments of the system and method for allocating human resources based on bio inspired models are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for allocating human resources based on bio inspired models is not intended to be limited to the embodiments illustrated, but is to be accorded the widest scope consistent with the principles and features described herein.

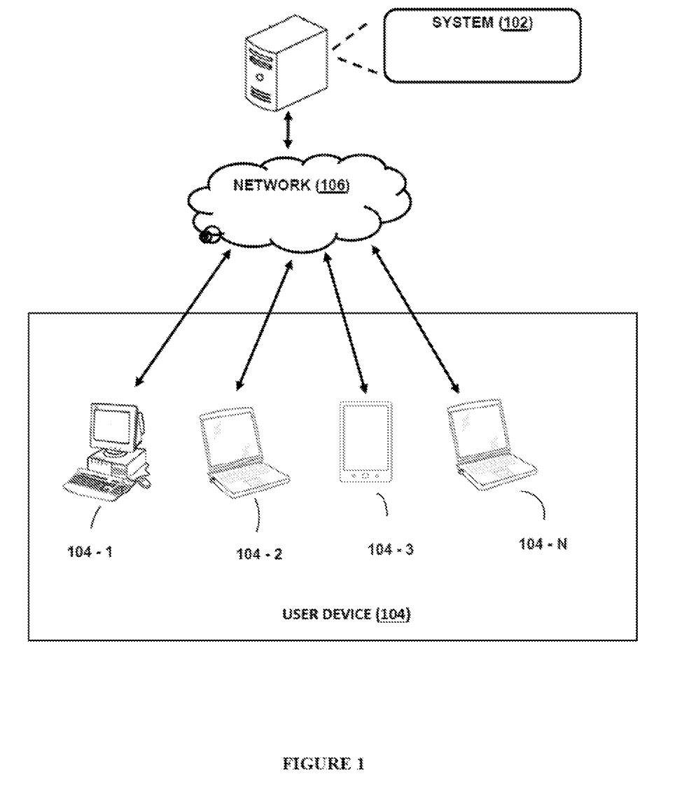

The present subject matter relates to allocating human resources. In one embodiment, primary data associated with a product under development may be received. The primary data may comprise a set of tasks, associated with the product under development. Once the primary data is received, a sub-set of human resources, from a set of human resources, maintained at a human resource database, may be identified using a resource identification algorithm. The human resource database may be configured to store human resource data. In one embodiment, the resource identification algorithm may be configured to analyse the set of tasks to identify the sub-set of human resources. Further, secondary human resource data may be extracted from the human resource database. The secondary human resource data may be associated with the sub-set of human resources, from the set of human resources. Further, one or more human resources, from the sub-set of human resources, may be allocated to each task from the set of human resources. In one embodiment, the one or more human resources may be allocated by applying a resource allocation algorithm to the secondary human resource data and the primary data. Further, the network implementation of system for allocating human resources based on bio inspired models is illustrated with FIG. 1.

Referring now to FIG. 1, a network implementation 100 of a system 102 for allocating human resources based on bio inspired models is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, it will be understood that the system 102 may be accessed by multiple users through one or more user devices 104-1, 104-2 . . . 104-N, collectively referred to as user device 104 hereinafter, or applications residing on the user device 104. Examples of the user device 104 may include, but are not limited to, a portable computer, a personal digital assistant, a handheld device, and a workstation. The user device 104 may be communicatively coupled to the system 102 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

In one embodiment, the system 102 may be configured to receive primary data, associated with a product under development, from the user device 104 based on user inputs. The primary data may comprise a set of tasks associated with the product under development. In one embodiment, the primary data may comprise product development duration, product development budget, required human efforts, a set of skills required for the set of tasks and the like. In one example, the system 102 may receive the primary data based on analysing a project proposal.

Further, the system 102 may identify a sub-set of human resources from a set of human resources, maintained at a human resource database, based on a resource identification algorithm. The resource identification algorithm may be configured to analyse the set of tasks to identify the sub-set of human resources, from the set of human resources. In one embodiment, the human resource database may be configured to maintain human resource data associated with the set of human resources. The human resource data may comprise human resource experience, human resource capability, human resource productivity for handling actions, projects completed by the human resource in past, human resource programming capability, language tool experience and the like. In one example, the resource identification algorithm may be derived from a Resource Ability Indication Metrics (RAIM) algorithm. In one embodiment, the resource identification algorithm may comprise a resource identification function. The resource identification function may be derived based on one or more parameters corresponding to a set of human resource skills, the set of skills required for the set of tasks, expected use of the set of human resource skills for the set of tasks, complexity of the set of human resource skill for the set of tasks, significance of the set of human resource skills for the set of tasks, relationship between level of knowledge of known human resource skill and level of knowledge of a skill required for the task, level of knowledge of the set of human resource for the set of tasks, relationship between the human resource and one or more skills known to the human resource, match level between each human resource and the set of tasks, and the like.

Once the sub-set of human resources is identified, the system 102 may be configured to extract secondary human resource data associated with the sub-set of human resources from the human resource database. In one embodiment, the secondary human resource data may be extracted based on analysis of the human resource database.

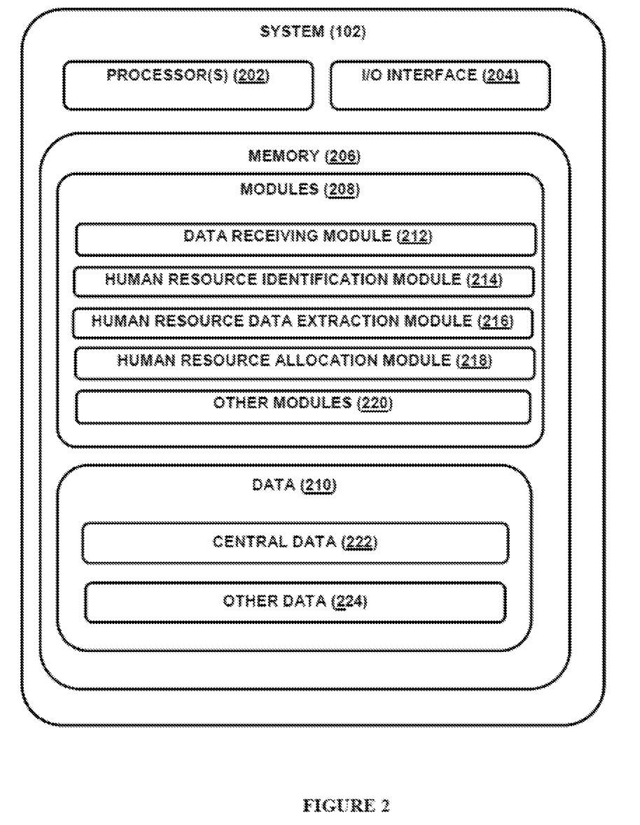

Upon extracting the secondary human resource data, the system 102 may be configured to allocate one or more human resources, from the sub-set of human resources, to each task from the set of tasks. In one aspect, the one or more human resource may be allocated based on a resource allocation algorithm. The resource allocation algorithm may be configured to allocate the one or more human resources based on analysis of the secondary human resource data and the primary data. In one example, the resource allocation algorithm may be derived from a set of bio inspired models. The set of bio inspired models may comprise an Artificial Bee Colony (ABC) algorithm, genetic algorithm, or an ant colony algorithm. In one aspect, the allocation of the one or more human resources to each task may be referred as an optimised allocation of the human resource. Further, the system for allocating human resources based on bio inspired models is elaborated with respect to FIG. 2.

Referring now to FIG. 2, the system 102 for allocating human resources based on bio inspired models is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include data receiving module 212, a human resource identification module 214, a human resource data extraction module 216, a human resource allocation module 218, and other modules 220. The other modules 220 may include programs or coded instructions that supplement applications and functions of the system 102.

The data 210, amongst other things, serve as a repository for storing data processed, received, and generated by one or more of the modules 208. The data 210 may also include a central data 222, and other data 224. In one embodiment, the other data 224 may include data generated as a result of the execution of one or more modules in the other modules 220.

In one implementation, a user may access the system 102 via the I/O interface 204. The user may be registered using the I/O interface 204 in order to use the system 102. In one aspect, the user may access the I/O interface 204 of the system 102 for obtaining information, providing input information or configuring the system 102.

In one embodiment, the data receiving module 212 may be configured to receive primary data associated with a product under development. In one example, the primary data may be received from the user device 104 based on inputs provided by a user. The primary data may comprise a set of tasks, associated with the product under development. In one embodiment, the set of tasks may correspond to development of the product, testing of the product, maintenance of the product and the like. In one example, the data receiving module 212 may be configured to generate a set of work packets based on packetization of the product under development. Further, each work-packet from the set of work-packets may correspond to a task from the set of tasks. In one example, the set of work-packets may be prioritized based on due date associated with each task from the set of tasks.

Further, the primary data may comprise product development duration, due date associated with each task, product development budget, required human resource efforts, a set of skills required for the set of tasks, and the like. Once the primary data is received, the data receiving module 212 may be configured to store the primary data at the central data 222.

Furthermore, upon receiving the primary data, the human resource identification 214 may be configured to identify a sub-set of human resources from a set of human resources based on a resource identification algorithm. The resource identification algorithm may be configured to analyse the set of tasks in order to identify the sub-set of human resources, from the set of human resources. In one embodiment, the set of human resources may be maintained at a human resource database. The human resource database may further maintain human resource data. In one embodiment, the human resource data may comprise human resource experience, human resource capability, language tool experience, project domain experience of human resource, human resource productivity for handling actions and the like. In one example, the resource identification algorithm may be derived from a Resource Ability Indicative Metrics (RAIM) algorithm.

In one aspect, the human resource identification module 214 may be configured to send a query to the human resource database. The query may correspond to identify the sub-set of human resources, from the set of human resources, based on the set of tasks. Upon sending the query, the human resource identification module 214 may compute match level between each human resource, from the set of human resources, and the one or more task from the set of tasks. In one embodiment, the match level may be based on the set of skills required for the set of tasks, the significance of the set of human resource skills for the set of tasks and the set of human resource skills. Thus, the sub-set of human resources, from the set of human resources, may be identified based on the match level between each human resource and each task from the set of tasks. In one embodiment, the sub-set of human resources may correspond to skilled human resources suitable for completing the set of tasks. In other words, the skilled human resourced may be able to complete the set of tasks efficiently and on time.

In one embodiment, the resource identification algorithm may enable the resource identification function based on one or more parameters. The one or more parameters may correspond to—

H—Represents a set of human resource skills,

H(t)—Represents the set of skills required for the set of tasks,

Eₖₜ—Represents expected use of a human resource skill j for a task t. Further, value of Eⱼₜ varies between 0 and 1. In this case, one (1) may indicate that the human resource skill is suitable for a task, and zero (0) may indicate that the human resource skill is not suitable for the task from the set of tasks.

Cⱼₜ—Represents complexity of a human resource skill for a task t. Further, the value of Cⱼₜ varies between 0 and 1. In this case, one (1) may indicate that level of complexity of the task considering the human resource skill is high, and zero (0) may indicate that the level of complexity of the task considering the human resource skill is low.

Sⱼₜ—Represents significance of a human resource skill j for a task t. Further, value of Sⱼₜ varies between 0 and 1. In this case, one (1) may indicate that the human resource skill is important to complete task t, and zero (0) may indicate that the human resource skill is not important for task t. Further, the Sⱼₜ may be computed using equation 1 as shown below:

Sjt=(Cjt×Ejt) Equation 1

Rⱼₖ—Represents relationship between level of knowledge of known human resource skill j and level of knowledge of a skill required for a task k. Further, Rⱼₖ varies between 0 and 1. In this case, one (1) may indicate that the level of knowledge of known human resource skill and skill required for the task is equal (i.e. j=k), and zero may indicate that there is no relationship between known human resource skill and skill required for the task.

L_{yj}—Represents level of knowledge of a human resource y for the skill required for a task j. Further, L_{yj} varies between 0 and 1. In this case, one (1) may indicate that the human resource is an expert in the skill required for the task, and zero (0) indicates that the human resource may not have knowledge of the skills required for the task.

B_{yj}—Represents relationship between a human resource y and skill j known to the human resource. Further, B_{yj} varies between 0 and 1. In this case, one (1) may indicate that the human resource is an expert in the skill known to the human resource, and zero (0) indicates that human resource may not have knowledge of skill or any other related skill.

F_{yt}—Represents match level between each human resource y and a task t,

The match level between human resource y and task t may be computed using equation 2 as below:

f_{yt}=Σ_{j∈H(t)}^{∞}(sⱼₜ×b_{yj}),∀y∀t Equation 2

Upon identifying the sub-set of human resources, the human resource data extraction module 216 may be configured to extract secondary human resource data, associated with the sub-set of human resources, from the historical database. The secondary human resource data may correspond to human resource experience, human resource capability, human resource language tool experience, project domain experience of human resource, human resource productivity for handling actions and the like. In one embodiment, the secondary human resource data may be extracted based on analysis of the human resource database using the sub-set of human resources.

Once the secondary human resource data is extracted, the human resource allocation module 218 may be configured to allocate one or more human resources from the sub-set of human resources to each task from the set of tasks, based on a resource allocation algorithm. In one embodiment, the resource allocation algorithm may be configured to analyse the secondary human resource data and the primary data to allocate the one or more human resources. In one example, the resource allocation algorithm may be derived from a set of bio inspired models. The set of bio inspired models may comprise an Artificial Bee Colony (ABC) algorithm, genetic algorithm, or an ant colony algorithm.

In one embodiment, the human resource allocation module 218 may be configured to initialize one or more parameters corresponding to the product development budget, the set of skills required for the set of task, human resource capability, human resource qualification, the set of human resource skills and the like. In one embodiment, the one or more parameters may be associated with the product under development and the sub-set of human resources. Once the one or more parameters are initialized, the human resource allocation module 218 may be configured to allocate each human resource, from the sub-set of human resources, to one task from the set of tasks. In one embodiment, the allocation of each human resource to one task may be a random allocation. Further, the human resource allocation module 218 may be configured to allocate one or more human resources, from the sub-set of human resources, to each task, from the set of tasks, based on comparing the match level between each human resource and each task from the set of tasks. In one aspect, according to the resource allocation algorithm number of human resources and number of tasks may be same.

In one aspect, the human resource allocation module 218 may be configured to initialize a set of constraints for allocation of each human resource, from the sub-set of human resources, to each task from the set of tasks. Further, first constraint, from the set of constraints, may state that each human resource may be allocated to at most one task, from the set of tasks. The first constraint may be stated as equation 3—

Σₜ₌₁^{T}X^{yt}<<1,∀y Equation 3

wherein,
X_{yt}—Represents allocating a human resource ‘y’ to task ‘t’.

Furthermore, second constraint, from the set of constraints, may state that it is mandatory to allocate one human resource, from the set of human resources, to each task from the set of tasks. The second constraint may be stated as equation 4—

E_{y=1}^{Y}X_{yt}=1,∀t Equation 4

wherein,
X_{yt}—represents allocating a human resource ‘y’ to task ‘t’.

Further, based on the set of constraints initialized by the human resource allocation module 218, the human resource allocation module 218 may be configured to re-allocate one human resource from the sub-set of human resource to only one task from the set of tasks. In this case, the human resource allocation module 218 may analyse association between each human resource and each task, from the set of tasks. The allocation may correspond to capability of the human resource to perform and complete that task effectively. In one embodiment, the re-allocation may be based on the association between one or more human resources and each task. In one example, the re-allocation may be referred as an optimized allocation of human resources to the set of tasks. Further, the allocation of each human resource to at most one task from the set of tasks may be shown with equation 5—

$${X}_{yt} = \{ \begin{matrix}1 & if resource assigned to task \\ 0 & otherwise\end{matrix} \qquad Equation 5$$

wherein,
X_{yt}—Represent allocating a human resource ‘y’ to task ‘t’.

Further, it may be inferred from equation 5 that the allocation of each human resource to at the most one task from the set of tasks may be indicated as one (1), when the human resource is allocated to the task. Furthermore, the allocation of human resource to task from the set of tasks may be indicated as zero (0), when the human resource is not allocated to the task.

In one exemplary embodiment, construe a human resource database comprising human resource data associated with a set of 15 human resources present in an organization. Further, the data receiving module 212 may receive primary data associated with a product under development. In one example, the product under development may be an online job search software. The primary data may comprise that set of tasks associated with the online job search software as 4 tasks, product development duration may be 6 months, a set of skills required for the set of tasks may comprise Java programming, analyst capability, software developer capability, and the like. Further, the human resource identification module 214 may be configured to identify a sub-set of 4 human resources from the set of 15 human resources. The human resource identification module 214 may identify the sub-set of 4 human resources based on the analysis of the set of tasks and using the resource identification algorithm. Once the sub-set of 4 human resources is identified, the human resource data extraction module 216 may be configured to extract secondary human resource data associated with the sub-set of 4 human resources. Further, R1, R2, R3 and R4 may be the human resources from the sub-set of 4 human resources. Furthermore, the tasks from the sets of 4 tasks may be T1, T2, T3 and T4.

Upon extracting the secondary human resource data, the human resource allocation module 218 may be configured to initialize the one or more parameters such as development budget of the product, human resource qualification, the set of human resource skills and the like. Further, the human resource allocation module 218 may allocate each human resource to at least one tasks from the set of 4 tasks, based on the one or more parameters. Thus, the allocation may be such that R1 may be allocated to T3, R2 may be allocated to T1, R3 may be allocated to T4 and R4 may be allocated to T2. Further, the human resource allocation module may reallocate the human resources to the set of tasks based on the match level between each human resource and each task. Thus, the allocation may be such that R1 may be allocated to [T3, T2], R2 may be allocated to [T1, T2, T4], R3 may be allocated to [T4], and R4 may be allocated to [T2, T1].

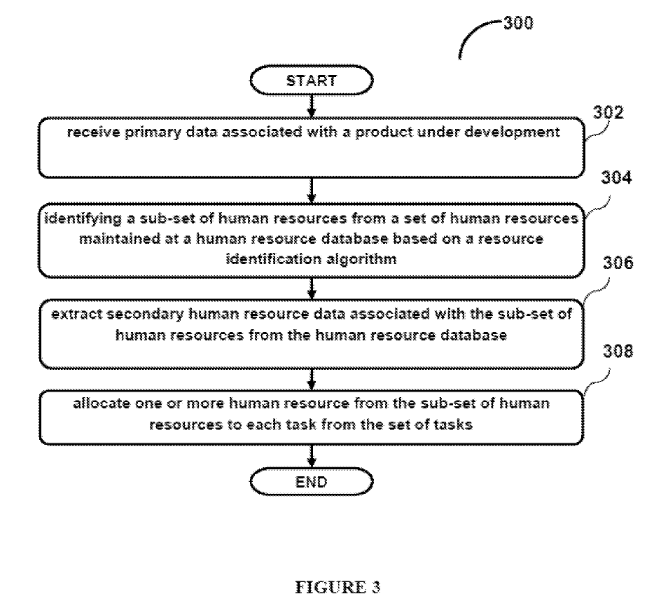

Further, the human resource allocation module 218 may analyse the association between each human resource and each task. Furthermore, the human resource allocation module 218 may finally allocate each human resource to at most one task from the set of 4 tasks. Thus, the human resource final allocation may be such that R1 may be allocated to T3, R2 may be allocated to T2, R3 may be allocated to T4 and R4 may be allocated to T1. Further, method for allocating human resources based on bio inspired models is illustrated with respect to FIG. 3.

Referring now to FIG. 3, a method 300 for allocating human resources based on bio inspired models, is disclosed in accordance with an embodiment of the present subject matter. The method 300 may be described in the general context of computer executable instructions. Generally, computer executable instructions can include routines, programs, objects, components, data structures, procedures, modules, functions, and the like, that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 may be considered to be implemented in the above described system 102.

At block 302, primary data associated with a product under development may be received. In one embodiment, the primary data may comprise a set of tasks associated with the product under development. In one implementation, the data receiving module 212 may be configured to receive the primary data. Further, the primary data may comprise product development duration, product development budget, required human resource efforts, a set of skills required for the set of tasks and the like.

At block 304, a sub-set of human resources from the set of human resources, maintained at a human resource database, may be identified based on a resource identification algorithm. The resource identification algorithm may be configured to analyse the set of tasks to identify the sub-set of human resources. In one example, the resource identification algorithm may be derived from a Resource Ability Indicative Metrics (RAIM) algorithm. The human resource database may be configured to maintain human resource data associated with the set of human resources. The human resource data may comprise human resource experience, human resources capability, human resource productivity and the like. In one implementation, the human resource identification module 214 may be configured to identify the sub-set of human resources.

At block 306, secondary human resource data associated with the sub-set of human resources may be extracted from the human resource database. In one implementation, the human resource data extraction module 216 may be configured to extract the secondary human resource data from the human resource database.

At block 308, the one or more human resources from the sub-set of human resources may be allocated to each task from the set of tasks. The allocation of the one or more human resources may be based on a resource allocation algorithm. The resource allocation algorithm may be configured to analyze the secondary data and the primary data to allocate the one or more human resources. In one embodiment, the resource allocation algorithm may be derived from a set of bio inspired models. The set of bio inspired models may comprise an Artificial Bee Colony (ABC) algorithm, genetic algorithm, or an ant colony algorithm. In one implementation, the human resource allocation module 218 may be configured to allocate the one or more human resources to each task from the set of tasks.

Although implementations for systems and methods for allocating human resources based on bio inspired models have been described, it is to be understood that the appended claims are not necessarily limited to the specific features or methods described. Rather, the specific features and methods are disclosed as examples of implementations for allocating human resources based on bio inspired models.

We claim:

1. A method for allocating human resources based on bio inspired models, the method comprises steps of:
receiving, by a processor, primary data associated with a product under development, wherein the primary data comprises a set of tasks associated with the product under development;
identifying, by the processor, a sub-set of human resources from a set of human resources, maintained at a human resource database, based on a resource identification algorithm, wherein the resource identification algorithm is configured analyse the set of tasks in order to identify the sub-set of human resources;
extracting, by the processor, secondary human resource data associated with each of the sub-set of human resources from the human resource database; and
allocating, by the processor, one or more human resource from the sub-set of human resources to each task from the set of tasks based on a resource allocation algorithm, wherein the resource allocation algorithm is configured analyse secondary human resource data and the primary data for allocating one or more human resources.

2. The method of claim 1, wherein the resource identification algorithm is derived from Resource Ability Indicative Metrics (RAIM) algorithm, wherein the resource allocation algorithm is derived from a set of bio inspired models, and wherein the set of bio inspired models comprise an Artificial Bee Colony (ABC) algorithm, genetic algorithm, or an ant colony algorithm.

3. The method of claim 1, wherein the primary data comprises product development duration, product development budget, required human efforts, and a set of skills required for the set of tasks.

4. The method of claim 1, further comprises generating a set of work packets, wherein each work packet corresponding to a task from the set of tasks, wherein the set of work packets are prioritized based on due date associated with each task.

5. The method of claim 1, wherein the human resource database is configured to maintain the human resource data associated with the set of human resources, wherein the human resource data comprises human resource experience, human resource capability, and human resource productivity.

6. The method of claim 1, wherein the resource identification algorithm comprises a resource identification function, wherein the resource identification function is derived based on one or more parameters corresponding to a set of human resource skills, the set of skills required for the set of tasks, expected use of the set of human resource skills for the set of tasks, complexity of the set of human resource skill for the set of tasks, significance of the set of human resource skills for the set of tasks, relationship between level of knowledge of known human resource skill and level of knowledge of a skill required for the task, level of knowledge of the set of human resource for the set of skills required for task, relationship between each human resource and one or more skills known to the human resource and match level between each human resource to the set of tasks.

7. The method of claim 1, wherein the identification of the sub-set of human resources based on the resource identification algorithm comprises steps of:
querying the human resource database to identify the sub-set of human resources based on the set of tasks;
computing a match level between each human resource and the one or more task from the set of tasks, wherein the match level is based on the set of skills required for the set of tasks, the significance of the set of human resource skills for the set of tasks; and
thereby identifying the sub-set of human resources based on the match level.

8. The method of claim 7, wherein the allocation of the set of human resources to the product by applying the resource allocation algorithm comprises steps of:
initializing one or more parameters associated with the product under development and the sub-set of human resources, wherein the one or more parameters correspond to development budget of the product, human resource qualification, and the set of human resource skills;
allocating each human resource from the sub-set of human resources, randomly, to at least one task from the set of tasks based on the one or more parameters;
re-allocating the one or more human resources to each task from the set of tasks based on the match level between each human resource and the set of tasks; and
re-allocating each human resource to at most one task from the set of tasks based on association between each human resource and each task from the set of tasks.

9. A system for allocating human resources based on bio inspired models, the system comprising:
a memory;
a processor coupled to the memory, wherein the processor is configured to execute programmed instructions stored in the memory to:
receive primary data associated with a product under development, wherein the primary data comprises a set of tasks associated with the product under development;
identify a sub-set of human resources from a set of human resources, maintained at a human resource database, based on a resource identification algorithm, wherein the resource identification algorithm is configured analyse the set of tasks in order to identify the sub-set of human resources;
extract secondary human resource data associated with each of the sub-set of human resources from the human resource database; and
allocate one or more human resource from the sub-set of human resources to each task from the set of tasks based on a resource allocation algorithm, wherein the resource allocation algorithm is configured analyse secondary human resource data and the primary data for allocating one or more human resources.

10. The system of claim 9, wherein the resource identification algorithm is derived from Resource Ability Indicative Metrics (RAIM) algorithm, wherein the resource allocation algorithm is derived from a set of bio inspired models, and wherein the bio inspired models comprise an Artificial Bee Colony (ABC) algorithm, genetic algorithm, or an ant colony algorithm.

11. The system of claim 9, wherein the primary data comprises product development duration, product development budget, required human efforts, and a set of skills required for the set of tasks.

12. The system of claim 9, further configured to generate a set of work packets, wherein each work packet corresponding to a task from the set of tasks, wherein the set of work packets are prioritized based on due date associated with each task.

13. The system of claim 9, wherein the human resource database is configured to maintain the human resource data associated with the set of human resources, wherein the human resource data comprises human resource experience, human resource capability, and human resource productivity.

14. The system of claim 9, wherein the resource identification algorithm comprises a resource identification function, wherein the resource identification function is derived based on one or more parameters corresponding to a set of human resource skills, the set of skills required for the set of tasks, expected use of the set of human resource skills for the set of tasks, complexity of the set of human resource skill for the set of tasks, significance of the set of human resource skills for the set of tasks, relationship between level of knowledge of known human resource skill and level of knowledge of a skill required for the task, level of knowledge of the set of human resource for the set of skills required for task, relationship between each human resource and one or more skills known to the human resource and match level between each human resource to the set of tasks.

15. The system of claim 9, wherein the identification of the sub-set of human resources based on the resource identification algorithm comprises steps of:
querying the human resource database to identify the sub-set of human resources based on the set of tasks;
computing a match level between each human resource and the one or more task from the set of tasks, wherein the match level is based on the set of skills required for the set of tasks, the significance of the set of human resource skills for the set of tasks; and
thereby identifying the sub-set of human resources based on the match level.

16. The system of claim 15, wherein the allocation of the set of human resources to the product by applying the resource allocation algorithm comprises steps of:
initializing one or more parameters associated with the product under development and the sub-set of human resources, wherein the one or more parameters correspond to development budget of the product, human resource qualification, and the set of human resource skills;
allocating each human resource from the sub-set of human resources, randomly, to at least one task from the set of tasks based on the one or more parameters;
re-allocating the one or more human resources to each task from the set of tasks based on the match level between each human resource and the set of tasks; and
re-allocating each human resource to at most one task from the set of tasks based on association between each human resource and each task from the set of tasks.

17. A computer program product having embodied thereon a computer program for allocating human resources based on bio inspired models, the computer program product comprises:
a program code for receiving primary data associated with a product under development, wherein the primary data comprises a set of tasks associated with the product under development;
a program code for identifying a sub-set of human resources from a set of human resources, maintained at a human resource database, based on a resource identification algorithm, wherein the resource identification algorithm is configured analyse the set of tasks in order to identify the sub-set of human resources;
a program code for extracting secondary human resource data associated with each of the sub-set of human resources from the human resource database; and
a program code for allocating one or more human resource from the sub-set of human resources to each task from the set of tasks based on a resource allocation algorithm, wherein the resource allocation algorithm is configured analyse secondary human resource data and the primary data for allocating one or more human resources.
